(19) United States
(12) Patent Application Publication
(10) Pub. No.: US 2003/0123321 A1
(43) Pub. Date: Jul. 3, 2003

(54) Method and apparatus for mixing

(76) Inventor: Philip Kenneth Freakley, Thornton (GB)

Correspondence Address: BRACEWELL & PATTERSON, L.L.P., P.O. Box 61389, Houston, TX, 77208-1389, US

(21) Appl. No.: 10/295,138

(22) Filed: Nov. 15, 2002

Related U.S. Application Data
(63) Continuation-in-part of application No. 09/646,313, filed on Mar. 27, 2001, now abandoned.

(30) Foreign Application Priority Data
Mar. 18, 1998 (GB) 9805609.6

(51) Int. Cl. B29B 7/38

(52) U.S. Cl. 366/79; 366/97; 366/100; 366/294

(57) ABSTRACT

A method for mixing flowable polymer material with particulate additive utilizes a continuous process. A pre-blend of the polymeric material and additive is made in a hopper. The pre-blend is compacted and fed into a first mixing arrangement to form an intermediate blend. The first mixing arrangement has a rotor with a helical flight located within a chamber. The intermediate blend is fed into a second mixing arrangement to form a final blend. The second mixing arrangement has a conical rotor with blades. The rotors of the first and second mixing arrangements are coaxial but operate at different speeds.

### CROSS REFERENCE TO RELATED APPLICATION

This application is a continuation-in-part of Ser. No. 09/646,313, filed Mar. 27, 2001, which was based on Application PCT/GB99/00768 (WO 99/47337), filed Mar. 15, 1999.

### FIELD OF THE INVENTION

This invention relates to mixing flowable polymeric material such as rubber or like elastomers with particulate additives, but which may also be adapted or adaptable to other polymers and indeed other material generally.

### BACKGROUND OF THE INVENTION

The rubber industry in particular requires to mix rubber or like elastomeric material with fillers such as carbon black or other additives. Conventionally, the elastomer is supplied in bale form, with a mass of some 20-25 kg. This has resulted in batch mixing operations being standard practice. Attempts have been made to introduce flexible, automated processes based on particulate rubber, but have not to date succeeded on account of both cost and problems with material behaviour.

Some plastics compounding equipment can be used for mixing some particulate rubber compounds, but, in general, elastomers have different characteristics from most thermoplastics and the results are far from optimal, and by no means all rubber elastomers can be processed using such equipment.

### SUMMARY

The present invention provides methods and apparatus for mixing flowable polymeric material with particulate additives which are suitable for both natural and synthetic rubbers, in particulate form, as well, incidentally, as thermoplastic and thermosetting polymers.

The invention comprises a method for mixing flowable polymeric material with particulate additives, comprising the steps of:

a) making a pre-blend of polymeric material and additive which pre-blend may be inhomogeneous and contain agglomerates;

b) compacting and feeding the pre-blend into a first mixing arrangement, the first mixing arrangement comprising a first chamber with a coaxial rotor having a helical flight;

c) rotating the rotor of the first chamber at a selected speed to form an intermediate blend;

d) feeding the intermediate blend into a second mixing arrangement, the second mixing arrangement comprising a second chamber with a rotor having a plurality of blades;

e) rotating the rotor of the second chamber at a speed that differs from the speed of rotation of the rotor of the first chamber to form a final blend;

f) outputting the final blend; and wherein

at least steps b), c), d), e) and f) of the method are carried out as a continuous process.

The first mixing arrangement may be a distributive mixing arrangement in which inhomogeneities are reduced. The second mixing arrangement may be a dispersive mixing arrangement in which agglomerates are broken down. However, the first mixing arrangement may be the dispersive mixing arrangement and the second the distributive mixing arrangement.

The polymeric material may itself be in particulate form or it may be in liquid state.

The pre-blend may be made by adding the polymeric material and particulate additive in desired proportions to a hopper from which the pre-blend is fed to the mixing arrangements, but, of course, a previously prepared pre-blend may be added directly to the hopper.

The pre-blend may, however, be fed from the hopper by a screw feeder and compactor arrangements. The screw may have a constant pitch, compaction being achieved by restriction of the exit from the feeder and compactor arrangement, which may comprise a thread-advanced closure member. The screw may have decreasing pitch or flight depth, however, towards the exit end to achieve or supplement compaction of the pre-blend.

Particulate filler may be added to a thermoplastic polymeric material in a melt screw feeder arrangement feeding the pre-blend to the distributive mixing arrangement. The melt screw feeder arrangement may promote melting of the thermoplastic polymeric material and accommodate an accompanying reduction in volume by reducing in pitch and/or flight depth in the direction of feed. The melt screw feeder arrangement may have an expansion zone at which the melt is decompressed and an inlet into the depressurised melt may be provided for the filler.

The distributive mixing arrangement may comprise a cylindrical chamber with a coaxial rotor, and the pre-blend may be introduced radially at an inlet end of the chamber.

The rotor of the distributive mixing arrangement may have a conveying and mixing screw having substantial clearance between the screw flight and the chamber wall facilitating backflow and decoupling the screw rotation from the feed rate of intermediate blend from the distributive mixing arrangement.

The pre-blend may be heated or cooled in the distributive mixing arrangement, as by passages therein for circulating fluid.

The dispersive mixing chamber may be coaxial with and arranged at the outlet of the distributive mixing chamber—the inlet end of the dispersive mixing chamber may merge with the outlet end of the distributive mixing chamber.

The dispersive mixing arrangement may comprise a blade arrangement rotating in a dispersive mixing chamber with narrow clearance from the chamber wall whereby the material is subject to elongational flow and shear flow. The dispersive mixing chamber may be conical, tapering towards its outlet, and the cone angle of the blade arrangement may be less than that of the dispersive mixing chamber wall whereby to decrease the blade-to-wall clearance towards the outlet of the chamber.

The cone angle of the blade arrangement may be constant from end to end or may vary from end to end.

The blade arrangement may comprise at least one blade which is (and may indeed comprise several blades which are) angled with respect to the axis of the blade arrangement so as to exert a conveying or pumping action on the intermediate blend being processed in the dispersive mixing arrangement. The blade angle, however, may be such that the conveying or pumping action is not strong enough to exert a dominant influence on the residence time of the intermediate blend in the dispersive mixing arrangement.

The material may be heated by virtue of the mechanical work done on it in feeding it to and/or treating it in the distributive mixing arrangement and this may be supplemented or controlled by additional heating or cooling by heating or cooling means in the dispersive mixing arrangement for example passages for heat exchange fluid.

Heat exchange passages may be provided advantageously in both chamber wall and rotor body in both mixing zones.

The final blend may be output to an extruder, or to a roller die or calendar means to produce sheet material, or, indeed, the dispersive mixing arrangement may output directly through an extrusion die.

### BRIEF DESCRIPTION OF THE DRAWINGS

Methods and embodiments of apparatus for mixing flowable polymeric materials with particulate additive according to the invention will now be described with reference to the accompanying drawings, in which:—

FIG. 1 is an axial section of a first embodiment;

FIG. 2 is a section on the line II-II of FIG. 1;

FIG. 3 is an axial section of a second embodiment;

FIG. 4 is an axial section of a third embodiment;

FIG. 5 is an axial section of a fourth embodimen; and

FIG. 6 is an axial section of a fifth embodiment.

### DETAILED DESCRIPTION OF THE INVENTION

The drawings illustrate methods and apparatus for mixing flowable polymeric materials, such as synthetic elastomers and natural rubbers in particulate form as well as thermosetting plastics, thermoplastics and thermoplastic elastomers, with particulate additives such as carbon black and other, including fibrous, filler materials.

A pre-blend of the polymeric material and additive, which pre-blend may be inhomogeneous and contain agglomerates, is made by adding the components either as an already mixed blend or separately in desired proportions to a hopper 11. The pre-blend is fed into a distributive mixing arrangement 12 in which inhomogeneities are reduced to form an intermediate blend. The intermediate blend is fed into a dispersive mixing arrangement in which agglomerates are broken down to form a final blend, which is then output, the process being carried out on a continuous basis.

The polymeric material may itself be in particulate form, which reflects recent attempts to introduce particulate rubbers to the rubber industry instead of the customary bale which has been the basis of the standard practice of batch processing. Liquid polymer, however, may also be handled by the apparatus.

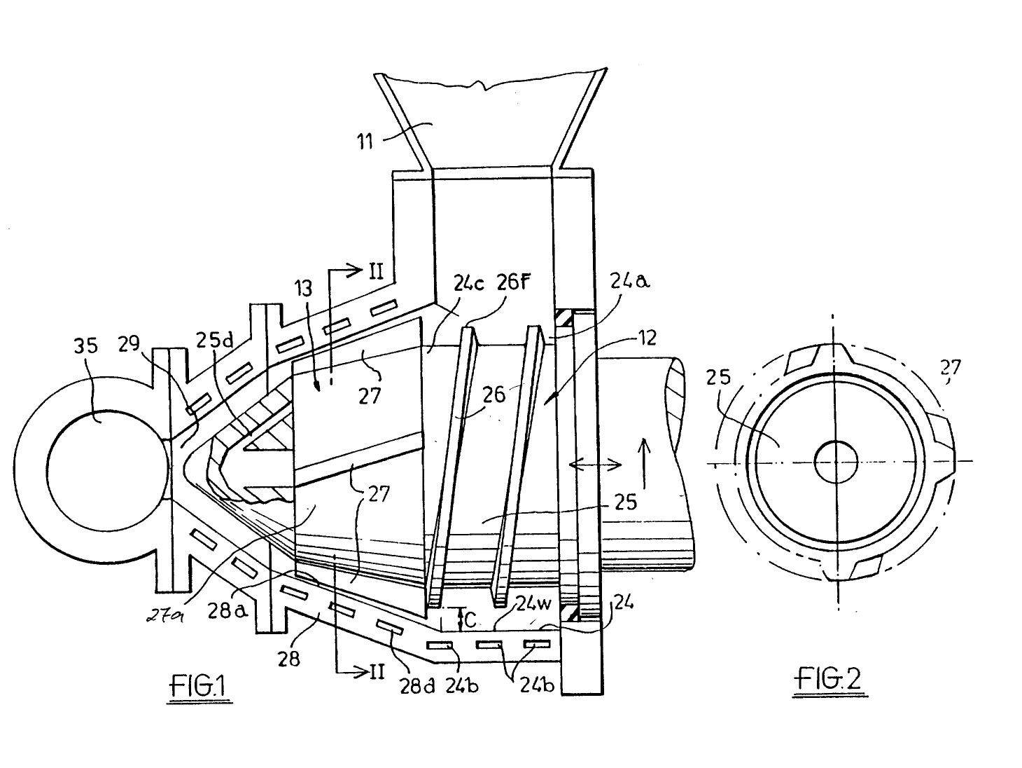

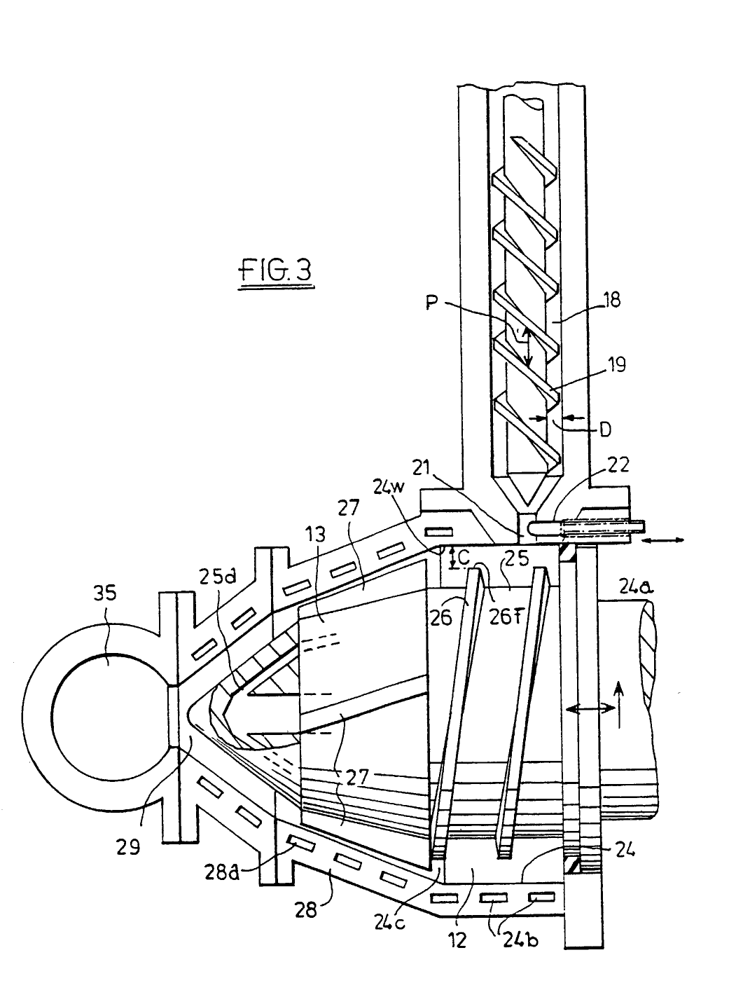

FIGS. 1 and 2 illustrate apparatus in which the pre-blend is fed from the hopper 11 to the distributive mixing arrangement 12.

FIG. 3 illustrates a horizontal screw feeder and compactor arrangement 18 feeding material from the hopper 11 to the distributive mixing arrangement 12. The screw 19 has constant pitch P and flight depth D and compaction is achieved and controlled by restriction of the exit 21 from the arrangement 18. (The compacted pre-blend may, in the parlance of the rubber industry, be termed □rubber compound□ at this stage). The restriction is brought about by an adjustable, thread-advanced closure member 22. If desired, however, additional compaction can be achieved with a screw 19 with progressively decreasing pitch and/or flight depth.

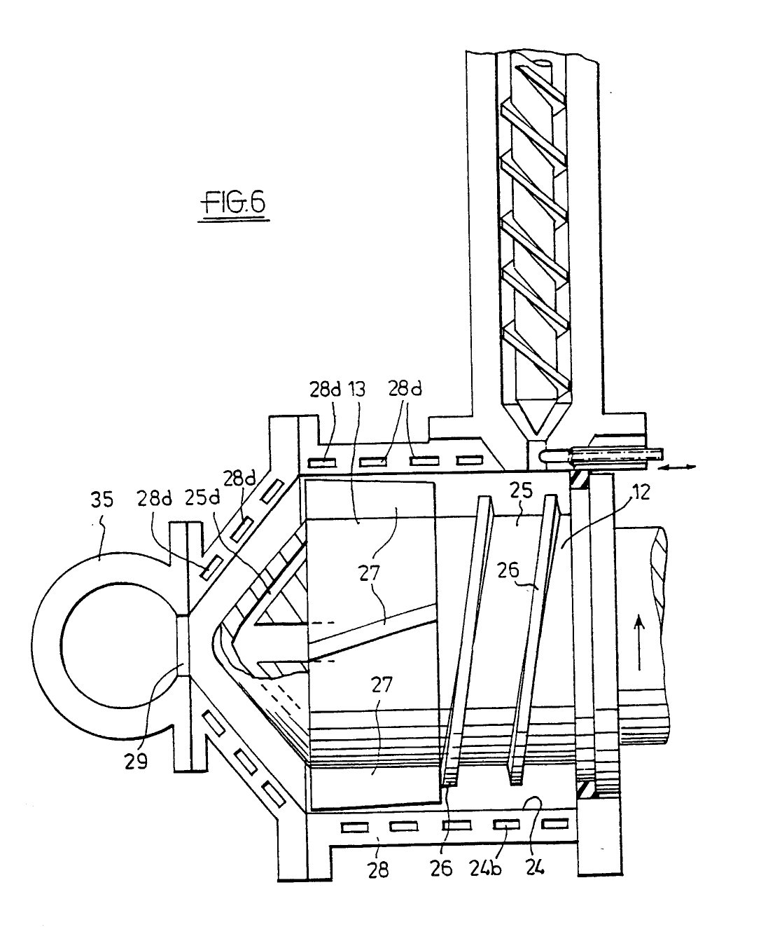

FIG. 5 illustrates a screw feeder and compactor arrangement 18 in which the flight depth D reduces towards the exit over a first extent E. In this extent (possibly with added heating) compaction of the polymer (thermoplastic in this case) melts it. An inlet 23 is provided at the end of the extent E where the flight depth D suddenly increases to reduce pressure, allowing filler material to be introduced through inlet 23, after which the material is re-pressurised to be fed to the distributive mixing arrangement 12. Introducing the filler in this way avoids or at least reduces wear problems associated with feeding an abrasive filler together with plastic granules or powder.

The distributive mixing arrangement comprises a cylindrical chamber 24 with a coaxial rotor 25. The pre-blend is introduced radially at an inlet end 24a of the chamber 24. The rotor 25 has a conveying and mixing screw 26 having substantial clearance C between the helical screw flight 26F and the chamber wall 24W, facilitating backflow and decoupling the pumping or conveying action of the rotating screw 26 from the feed rate of intermediate blend from the distributive mixing arrangement. The pre-blend may well be heated up by the mechanical work done on it in the distributive mixing chamber 24, but cooling or additional heating can be supplied by circulating fluid at an appropriate temperature and flow rate in channels 24b.

The dispersive mixing arrangement 13 comprises a blade arrangement 27 on a downstream rotor 27a that rotates in a dispersive mixing chamber 28 with narrow clearance from the chamber wall 28a whereby the material is subject to elongational flow and shear flow. The chamber 28 is conical, tapering towards its outlet 29, and is coaxial with and arranged at the outlet 24c of the distributive mixing chamber 24.

The blade arrangement 27 may be carried on the same rotor 25 as the conveying and mixing screw 26, however, is preferably carried on a separate coaxial rotor 27a, which is tapered like the chamber 28, but with a lesser cone angle to increase compaction of the material towards the outlet 29. (The cone angle could on the other hand be greater in certain circumstances, or the same as that of the chamber). The blade arrangement 27 has a cone angle which is less than that of the chamber 28 to decrease the blade-to-wall clearance towards the outlet 29—this, too, could be the same or greater. As illustrated, the blade cone angle is constant from end to end, but could vary, perhaps in order to provide a longer length quite close to the wall of the chamber 28 for more effective dispersion of small agglomerates. The maximum clearance between blades 27 and the wall of chamber 28 is preferably less than clearance C between helical flights 26 and chamber wall 24W.

The blade arrangement 27 comprises a plurality of circumferentially spaced elongated blades. Blades 27 extending generally upstream and downstream, but are angled with respect to the axis of the arrangement so as to exert a conveying or pumping action on the intermediate blend being processed in the dispersive mixing arrangement, but the blade angle is such that the conveying or pumping action is not strong enough to exert a dominant influence on the residence time of the intermediate blend in the dispersive mixing arrangement 13.

The material will be further heated by virtue of the mechanical work done on it in the dispersive mixing arrangement 13. The temperature of the material may be controlled by additional heating or cooling through fluid channels 25d, 28d, to maintain the material at an optimal temperature for processing.

FIG. 5 illustrates an arrangement for introducing fibre filler materials into the compound. The output 29 from the dispersive mixing arrangement 13 is into a screw feed arrangement 31 with an inlet port 32 for the fibre filler. The screw 33 decreases in flight depth to feed and compact the rough mix of polymer and fibre, and delivers the rough mix to a pin barrel mixing arrangement 34 for distributive mixing of the fibres. If only fibre is to be used to fill the material, the precise details of the distributive and dispersive mixing arrangements 12, 13 are of less importance.

In all illustrated embodiments, embodiments, the rotor 25 is adjustable towards and away from the outlet 29 to vary the rotor blade-to-chamber wall clearance in the dispersive mixing arrangement to accommodate a wide range of compound types. However, a simple, less expensive construction would have a constant clearance.

FIG. 6 illustrates a budget version of the mixer in which the rotor 25 is a) not adjustable (or not necessarily adjustable) towards and away from the outlet 29 and b) cylindrical, rather than tapered (except for the end cone 25a). The blades 27 reduce in clearance from the chamber wall towards the outlet 29.

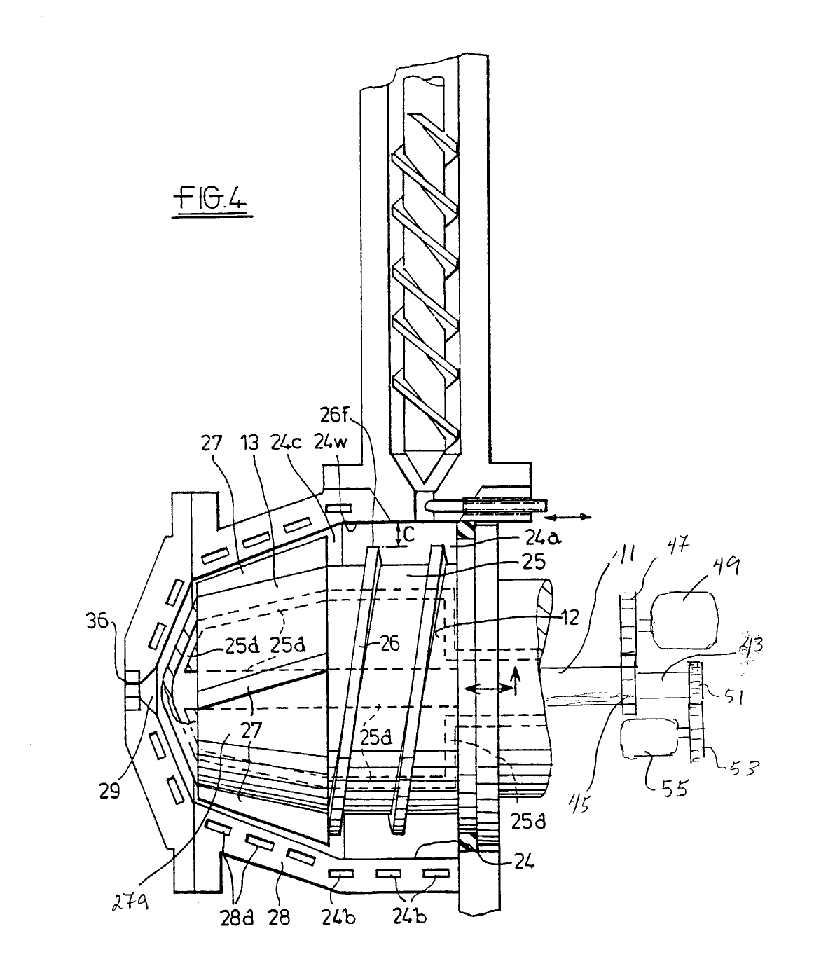

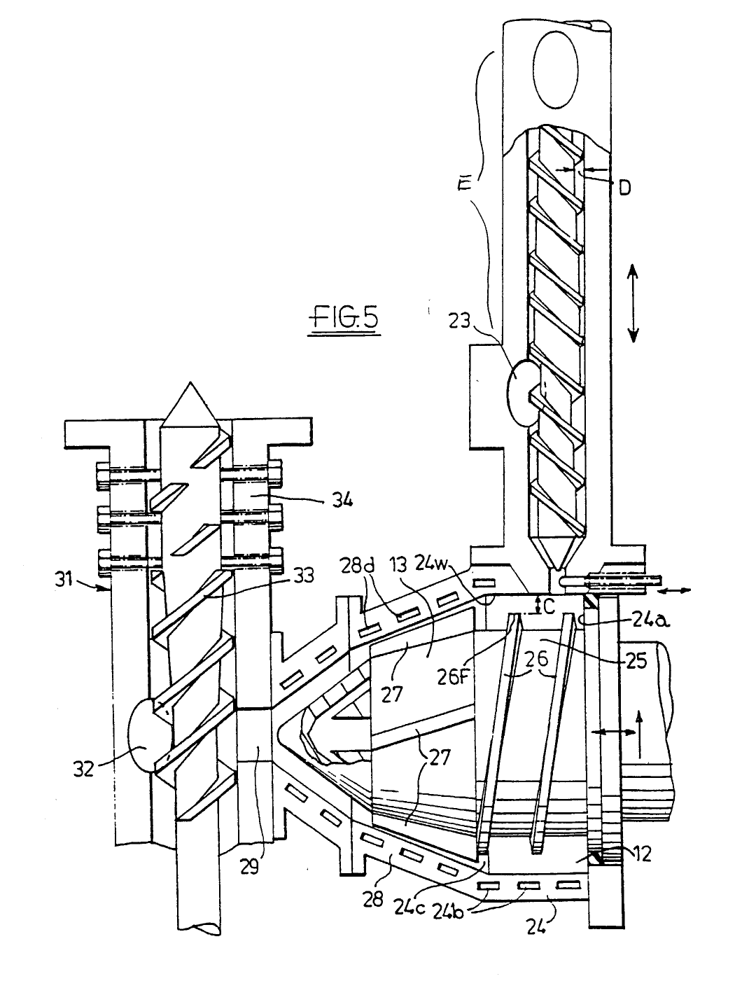

FIGS. 3 and 6 illustrate the outlet 29 connected to an extruder 35 (which can be vertical, as shown, or horizontal, as in FIG. 5), while FIG. 4 shows an extrusion die 36 fixed directly on to the outlet 29. A roller die or calendar means could, of course, be connected for the production of sheet material.

The distributive mixing arrangement 12 and dispersive mixing arrangement 13 are preferably independent from each other such that upstream rotor 25 can be rotated at different speeds from downstream rotor 27a. For example, downstream rotor 27a can be rotated at a lower speed, and the overall rate of throughput can be increased by increasing the rate of rotation of upstream rotor 25 to a rate faster than the rotation of downstream rotor 27a. This causes a high level of mixing in distributive section 12 without causing an overly high rate of flow through the dispersive mixing section 13, allowing a more thorough dispersive mixing. Alternately, the rate of throughput can be reduced by decreasing the rate of pumping or rotation of upstream rotor 25 relative to downstream rotor 27a. This feeds the intermediate blend to rotor 27 at a slower rate than if the rotors 25 and 27a are rotated at the same speed.

Various mechanisms may be employed to achieve the differential rotation speeds of rotors 25 and 27a. Referring to FIG. 4, a shaft 41 for upstream rotor 25 is secured to the interior of rotor 25 for rotating rotor 25. A shaft 43 passes through the hollow interior of shaft 41 and is secured to the interior of downstream rotor 27a for rotating rotor 27a. Each shaft 41, 43 is independently rotatable. In this embodiment, shaft 41 has a gear 45 that engages a gear 47 that is driven by a motor 49. Similarly, shaft 41 protrudes past shaft 41 and has a gear 51 that meshes with a gear 53. Gear 53 is driven by a motor 55. Preferably a controller (not shown) for each motor 49, 55 drives the motors 49, 55 at selected variable speeds.

For rubber production, a normal feedstock may be a particulate pre-blend of some or all of the ingredients of a rubber compound, possibly with separately metered pelleted polymer and filler. Variables such as temperatures at various stages of mixing, back pressures, as set by various mechanical adjustments and dwell times or throughput rates as they are affected by the speeds of the rollers and screws or rotors as appropriate will all be set to provide optimal throughput rates and rubber properties.

Some compounds, such as silica filled compounds have characteristics which may require two or more stages of mixing, which may be effected by successive passes through the same apparatus, or in a single pass through a succession of connected apparatus.

If the pre-blend has already near uniformity of composition, the distributive mixing arrangement can be dispensed with altogether as such, though, clearly, some redistribution and improvement in uniformity will be achieved at one or both ends of a single dispersive mixing arrangement.

1. A method for mixing flowable polymer material with particulate additive, comprising the steps of:
a) making a pre-blend of polymeric material and additive which pre-blend may be inhomogeneous and contain agglomerates;
b) compacting and feeding the pre-blend into a first mixing arrangement, the first mixing arrangement comprising a first chamber with a coaxial rotor having a helical flight;
c) rotating the rotor of the first chamber at a selected speed to form an intermediate blend;
d) feeding the intermediate blend into a second mixing arrangement, the second mixing arrangement comprising a second chamber with a rotor having a plurality of blades;
e) rotating the rotor of the second chamber at a speed that differs from the speed of rotation of the rotor of the first chamber to form a final blend;
f) outputting the final blend; and wherein
at least steps b), c), d), e) and f) of the method being carried out as a continuous process.

2. The method according to claim 1, wherein step e) comprises rotating the rotor of the second chamber rotates at a slower speed than the rotor of the first chamber.

3. The method according to claim 1, wherein step e) comprises rotating the rotor of the second chamber at a faster speed than the rotor of the first chamber.

4. The method according to claim 1, wherein step d) comprises providing a clearance between a wall of the second chamber and the blades that is less than a clearance between a wall of the first chamber and the helical flight.

5. The method according to claim 1, wherein step d) comprises aligning the rotor of the second chamber coaxially with the rotor of the first chamber.

6. The method according to claim 1, wherein step b) comprises providing the first chamber with a cylindrical wall, and step d) comprises providing the second chamber with a conical wall.

7. The method according to claim 1, wherein:
step b) comprises providing the first chamber with a cylindrical wall that is spaced from the helical flight by a selected clearance; and
step d) comprises providing the second chamber with a conical wall that is spaced from the blades by a clearance that is less than the clearance in the first chamber.

8. The method according to claim 1, wherein:
step b) comprises providing the first chamber with a cylindrical wall that is spaced from the helical flight by a selected clearance; and
step d) comprises providing the second chamber with a cylindrical wall that is spaced from the blades by a clearance that is less than the clearance in the first chamber.

9. The method according to claim 1, wherein step a) comprises:
adding the polymeric material to the additive in a particulate form in a hopper to form the pre-blend; and step b) comprises:
feeding the pre-blend from the hopper to the first chamber by a screw feeder and compactor arrangement.

10. The method according to claim 1, wherein step b) comprises feeding the pre-blend into the first chamber with a screw feeder that has a constant pitch and compacting the pre-blend by adjusting the size of the outlet of the screw feeder into the first chamber.

11. The method according to claim 1, wherein step a) comprises adding the polymeric material to the additive in a particulate form in a hopper to form the pre-blend; and step b) comprises:
feeding the pre-blend from the hopper to the first chamber by a screw feeder and compactor arrangement and causing melting of the pre-blend to occur within the screw feeder.

12. The method according to claim 1, wherein step a) comprises adding the polymeric material to the additive in a particulate form in a hopper to form the pre-blend; and step b) comprises:
feeding the pre-blend from the hopper to the first chamber by a screw feeder and compactor arrangement, the screw feeder having an upstream section with a flight depth that is greater than a downstream section, causing a pressure reduction at a junction between the upstream and downstream sections; and
feeding a filler material into an inlet of the screw feeder provided at the junction.

13. The method according to claim 1, wherein step d) comprises providing a clearance between the blades of the rotor of the second chamber and a wall of the second chamber that decreases in a downstream direction.

14. The method according to claim 1, wherein step d) comprises providing the second chamber with a conical wall that is at a first conical angle, and providing the blades of the rotor of the second chamber with a conical surface of revolution that is at a second conical angle, the first conical angle being greater than the second conical angle relative to an axis of the rotor of the second chamber.

15. A method for mixing flowable polymer material with particulate additive, comprising the steps of:
a) providing an upstream chamber section with an upstream rotor having a helical flight and a downstream chamber section with a downstream rotor that is coaxial with the upstream rotor, the downstream rotor having a plurality of circumferentially spaced-apart blades, the outer edges of which define a conical surface of revolution, each of the blades being elongated and extending generally in an upstream and downstream direction, the upstream chamber section having a lateral inlet and an axial outlet that leads into the downstream chamber section;
b) rotating the upstream rotor at a different speed than the downstream rotor;
c) making a pre-blend of polymeric material and additive;
d) compacting and feeding the pre-blend into the inlet of the upstream chamber section while the rotors are rotating, and forming an intermediate blend in the upstream chamber section; and
e) flowing the intermediate blend out the outlet of the upstream chamber section into the downstream chamber section, the rotation of the downstream rotor forming a final blend that flows out of the downstream chamber section.

16. The method according to claim 15, wherein step b) comprises rotating the downstream rotor at a slower speed than the upstream rotor.

17. The method according to claim 15, wherein step b) comprises rotating the downstream rotor at a faster speed than the upstream rotor.

18. The method according to claim 15, wherein step a) comprises providing a clearance between a wall of the downstream chamber section and the blades that is less than a clearance between a wall of the upstream chamber section and the helical flight.

19. The method according to claim 15, wherein step a) comprises providing the upstream chamber section with a cylindrical wall that is spaced from the helical flight by a selected clearance, and providing the downstream chamber section with a conical wall that is spaced from the blades by a clearance that is less than the clearance in the first chamber.

20. The method according to claim 19, wherein the clearance between the conical wall and the blades decreases in a downstream direction.

21. The method according to claim 15, wherein step c) comprises:
adding the polymeric material to the additive in a particulate form in a hopper to form the pre-blend; and step d) comprises:
feeding the pre-blend from the hopper to the upstream chamber section by a screw feeder and compactor arrangement.

22. The method according to claim 15, wherein step d) comprises feeding the pre-blend into the upstream chamber section with a screw feeder that has a constant pitch and compacting the pre-blend by flowing the pre-blend through an adjustable orifice into the upstream chamber section.

23. The method according to claim 15, wherein step c) comprises adding the polymeric material to the additive in a particulate form in a hopper to form the pre-blend; and step d) comprises:
feeding the pre-blend from the hopper to the upstream chamber section by a screw feeder and compactor arrangement and causing melting of the pre-blend to occur within the screw feeder.

24. The method according to claim 15, wherein step c) comprises adding the polymeric material to the additive in a particulate form in a hopper to form the pre-blend; and step d) comprises:
feeding the pre-blend from the hopper to the upstream chamber section by a screw feeder and compactor arrangement, the screw feeder having an upstream section with a flight depth that is greater than a downstream section, causing a pressure reduction at a junction between the upstream and downstream sections; and
feeding a filler material into an inlet of the screw feeder provided at the junction.

25. An apparatus for mixing flowable polymer material with particulate additive, comprising:
an upstream chamber section having a lateral inlet for receiving a pre-blend of polymer and an additive;
an upstream rotor mounted in the upstream chamber section, the upstream rotor having a helical flight;
an upstream rotor drive member mounted to the upstream rotor for rotating the upstream rotor to cause the pre-blend to form into an intermediate blend;
a downstream chamber section joining the upstream chamber section for receiving the intermediate blend, the downstream chamber section having an axial outlet;
a downstream rotor mounted in the downstream chamber section coaxial with the upstream rotor, the downstream rotor having a plurality of blades; and
a downstream drive member mounted to the downstream rotor for rotating the downstream rotor at a different speed than the upstream rotor to form a final blend for flowing out the outlet.

26. The apparatus according to claim 25, further comprising a clearance between a wall of the downstream chamber section and the blades that is less than a clearance between a wall of the upstream chamber section and the helical flight.

27. The method according to claim 25, wherein the upstream chamber section has a cylindrical wall that is spaced from the helical flight by a selected clearance, and the downstream chamber section has a conical wall that is spaced from the blades by a clearance that is less than the clearance in the first chamber.

28. The apparatus according to claim 27, wherein the clearance between the conical wall and the blades decreases in a downstream direction.

29. The apparatus according to claim 25, further comprising:
a hopper for receiving the polymer and the additive; and
a screw feeder that has a constant pitch and an adjustable orifice at a downstream end of the screw feeder, the screw feeder leading from the hopper into the inlet of the upstream chamber section.

30. The apparatus according to claim 25, wherein the screw feeder has an upstream section with a flight depth that is greater than a downstream section, causing a pressure reduction at a junction between the upstream and downstream sections; and
an inlet in the screw feeder is provided at the junction for receiving a filler material.
